(19) United States
(12) Patent Application Publication
(10) Pub. No.: US 2026/0031106 A1
(43) Pub. Date: Jan. 29, 2026

(54) READ AFTER WRITE IN A MULTIPLE REVOLUTION HARD DISK DRIVE

(71) Applicant: Seagate Technology LLC, Fremont, CA (US)

(72) Inventors: Riyan Alex Mendonsa, Edina, MN (US); Jon D. Trantham, Chanhassen, MN (US)

(21) Appl. No.: 19/276,097

(22) Filed: Jul. 22, 2025

Related U.S. Application Data
(60) Provisional application No. 63/674,398, filed on Jul. 23, 2024.

(51) Int. Cl. G11B 20/00; G11B 5/09; G11B 20/10

(52) U.S. Cl. CPC G11B 20/00963; G11B 5/09; G11B 20/10046

(57) ABSTRACT

Described are systems and methods for performing read after write operations in multi-revolution hard disk drives, which involve comparing the results of a read after write operation to a conditioned version of the write data that is retained in buffer memory. By conditioning the write data, a synthetic read-back signal can be fashioned that emulates the signal produced when reading the magnetic disk. Such an emulated read-back signal can be directly compared to the signal read from the magnetic disk by correlation and threshold checking, or the emulated read-back signal can be combined with the read-back signal and then compared against the write data residing in the buffer memory in a data verification operation. The data verification may be qualitative so that error codes may be developed and stored.

### CROSS REFERENCE TO RELATED APPLICATIONS

The present application claims the benefit under 35 U.S.C. § 119 (e) of U.S. Provisional Patent Application 63/674,398, filed on Jul. 23, 2024, which is hereby incorporated by reference in its entirety.

### TECHNICAL FIELD

The disclosure relates to techniques for performing read after write data validation in a hard disk drive.

### SUMMARY

In accordance with various aspects, the present disclosure provides read after write methods for use with a multiple revolution hard disk drive that includes a buffer memory and a magnetic storage disk. Such methods include, while write-data resides in the buffer memory, writing the write-data to the magnetic storage disk and, after writing, reading the write-data from the magnetic storage disk to thereby produce a read-back signal. The write-data residing in the buffer memory may be conditioned, shaped, or filtered to thereby produce an emulated read-back signal. Qualitative data verification is performed by comparing the read-back signal to the emulated read-back signal or by comparing a combination of the read-back signal and the emulated read-back signal to the write-data.

In certain aspects of methods in accordance with the present disclosure, conditioning, shaping, or filtering the write-data may involve using a moving Gaussian filter, using neighboring track information, adding noise, including signal features that match signals or noise produced during reading by a recording head of the hard disk drive and/or by the magnetic storage disk, using finite impulse response filtering, using a moving average filter, applying adaptive filtering, and so forth.

In certain aspects of methods in accordance with the present disclosure, performing qualitative data verification may be done in a bit-by-bit or point-by-point manner, and may be done using signal correlation based on thresholds.

In certain aspects of methods in accordance with the present disclosure, results of the qualitative data verification may be stored as error correction codes. The error correction codes may be stored as outer code on a dedicated region of the magnetic storage disk, as a values table in an SMR band, in a non-volatile memory (such as flash) separate from the magnetic storage disk, and the like.

In certain aspects of methods in accordance with the present disclosure, the read-back signal is produced by averaging results of reading the write-data from the magnetic storage disk two or more times.

In accordance with various aspects, the present disclosure provides methods for use with a hard disk drive that includes a magnetic media disk and that is operated in a high-density multi-rev mode. Such methods include performing read after write operations to verify write-data written to the magnetic media disk while operating in the high-density multi-rev mode, the read after write operations using a read-back signal and a conditioned version of the write-data, the read-back signal produced by reading the write-data from the magnetic media disk. The read-back signal may be produced by reading the write-data from the magnetic media disk once or by averaging results of reading the write-data from the magnetic media disk multiple times.

In certain aspects of methods in accordance with the present disclosure, the read-back signal is combined with the conditioned version of the write-data to produce an emulated read-back signal that is compared with the write-data in the performing of read after write operations.

In certain aspects of methods in accordance with the present disclosure, the read-back signal is directly compared to the conditioned version of the write-data in the performing of read after write operations.

In certain aspects of methods in accordance with the present disclosure, performing read after write operations produces qualitative data verification information that may be stored as error correction codes.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a schematic representation of modules for performing read after write verification in a hard disk drive in accordance with aspects of the present disclosure.

FIG. 2 is a is a schematic representation of modules for performing read after write verification in a hard disk drive in accordance with aspects of the present disclosure.

FIG. 3 is a flow chart depicting certain steps that may be performed in accordance with aspects of the present disclosure.

### DETAILED DESCRIPTION

The present disclosure relates to read verification after writing data to magnetic media in a hard disk drive (HDD) that utilizes multiple revolution processes to thereby increase data storage density. Multiple revolution HDDs (also referred to as multi-pass or multi-rev HDDs) are hard drives configured to use multiple disk revolutions (or revs) to read and write the data to and from spinning magnetic media disks. HDDs may be configured for multi-rev operation when the data is recorded (or to be recorded) at densities higher than what would provide a normal signal-to-noise ratio during reading over a single revolution. As such, averaging over multiple revs can reduce the noise, but at the cost of lower performance. As disclosed in U.S. Pat. No. 12,347,454, entitled “High-Density Archival Storage Using Conventional Hard Disk Drive Architecture,” which is herein incorporated in its entirety, HDDs may be configured for multi-rev operation for archival storage applications.

Performing read after write (RAW) operations to validate the data that has been written to the disk can pose challenges in multi-rev drives. For example, when it is desirable to evaluate the track that was just written on the disk, or to evaluate the victim track in the case of shingled magnetic recording (SMR), performing RAW operations can quickly multiply the number of revs in a multi-rev device that is already being operated under reduced performance conditions. A similar challenge exists for test time in a multi-rev HDD, since to evaluate the capacity of the drive, additional revs would be needed for readback, thus increasing test time. Moreover, in an SMR system the challenges posed by RAW operations leading to increased revs are compounded because, if there is an issue with the victim track, then two tracks need to be rewritten (the victim track and the last written track). This can result in the loss of multiple revs and can lead to a cascade effect that may destroy an entire band.

As such, in various aspects the present disclosure provides methods for performing RAW operations in a multi-rev drive by comparing the results of a single read after write revolution to a conditioned (or “filtered,” as equivalently used herein) version of the write data that is retained in buffer memory. By conditioning or filtering the write data, a synthetic read-back signal can be fashioned that emulates the signal produced when reading the magnetic disk. Such an emulated read-back signal can be directly compared to the signal read from the magnetic disk by correlation and threshold checking. The emulated read-back signal can also be combined (averaged) with the signal read from the magnetic disk and then compared against the write data residing in the buffer memory in a data verification operation. In either case, the verification performed may be qualitative, meaning that rather than simply deciding if the disk read is good or not good, it may be determined the degree to which the disk read resembles the write data so that error codes may be developed and stored without the need to overwrite the track. In SMR applications, when storing correction data it may be taken into account that the last track is a “fat” track that may have a lower error rate than the other (narrower) shingled tracks in the band. Thus, while the quality of the data in the last track is expected to be higher, RAW verification and rewriting may still be warranted.

Filtering the write data can take place using one or more signal shaping filters used alone or in combination. For example, the shaping filter(s) may be adaptive or tuned to match signals produced by the recording head, signals read from the magnetic media, and other variations and combinations, as encountered during the test process itself. Moreover, a noise component may be added during conditioning based on expected or detected system parameters. Examples of filtering techniques include adding a Gaussian filter based on the reader profile, finite impulse response (FIR), non-linear adjustments based on the characteristic profile of the reader, or using a moving average filter. Adaptive filtering and AI techniques can also be used. Cross-track information can also be used as part of the filtering process to further emulate the read-back track.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar. It will also be appreciated that the drawings are meant to illustrate certain aspects and arrangements of features in a way that contributes to their understanding and are not meant to be scale drawings that accurately represent size or shape of elements.

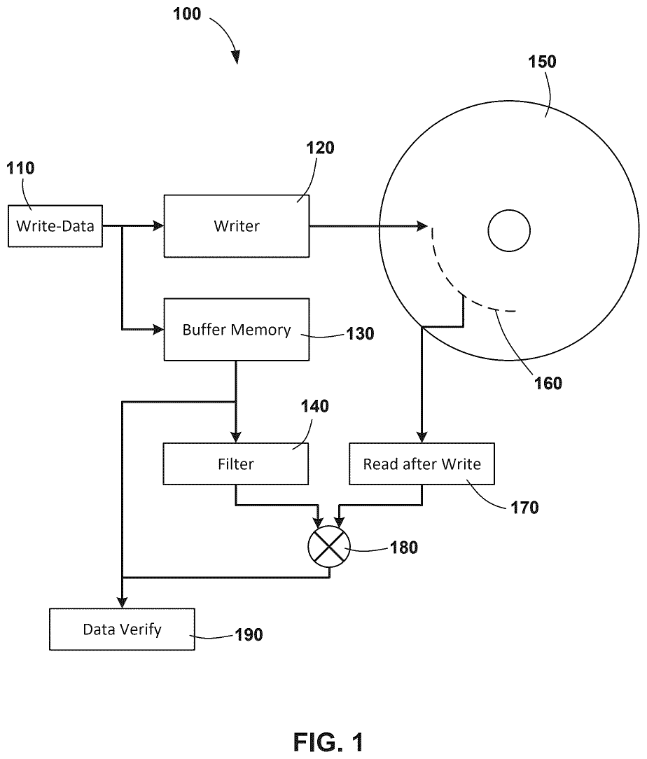

FIG. 1 schematically depicts a RAW method performed in the context of a multi-rev HDD 100 in accordance with aspects of the present disclosure. Upon receiving write-data 110 to be written onto magnetic disk 150, the write-data 110 may be conditioned (for example, using preamp circuitry) and provided to the writer 120 of a recording head that is suspended over spinning magnetic disk 150. The writer 120 writes a data track 160 on the disk 150 to thereby record the write-data 110. Concurrently with or prior to writing onto the disk, the write-data may be saved in buffer memory 130 such as DRAM or other volatile or non-volatile memory. To test, or verify, that the write-data was accurately recorded and retrievable, a read after write 170 can be performed whereby the data track 160 is read back by a reader on the recording head while the write-data 110 still resides in the buffer memory 130.

Because multi-rev drive 100 records at high densities, it would typically be required to perform multiple RAWs and combine the results in order to verify the writing of the data track 160. In accordance with the present disclosure, rather than averaging multiple RAWs over multiple revs, a single RAW read-back signal 170 may be averaged with an emulated read-back signal, which is then verified against the write-data 110 in the buffer memory 130. An emulated read-back signal may be produced by conditioning the write-data with a signal shaping filter 140. Filter 140 conditions the write-data signal to look like a read-back signal expected to be produced when a data track is read back from the magnetic disk 160. The shaping filter 140 may include a moving Gaussian filter to simulate an ideal or expected waveform. The shaping filter 140 may alternatively or additionally include information retrieved from neighboring tracks. The shaping filter 140 may alternatively or additionally include non-linearities or noise to represent expected and/or detected noise sources. The filter may also take into consideration head media spacing, skew, and timing irregularities. The emulated read-back signal produced by filter 140 is then combined 180 with the RAW read-back signal 170. The combined (or averaged) signal is then verified 190 against the write-data 110 by passing it through the full channel and performing a bit compare or other correlation. The data verify step 190 may entail using a standard sequence detector or soft output Viterbi algorithm (SOVA).

Once it is determined whether the data track 160 is good or not and where any errors may reside, the errors may be tracked in a correction code rather than rewriting the track. For example, an outer code or a simple fault table placed at the end of an SMR band or in a given region of the drive may be used to store corrections rather than rewriting the track. Corrections may be stored off the disk as well, for example in flash memory or other non-volatile media, or even as part of the host system.

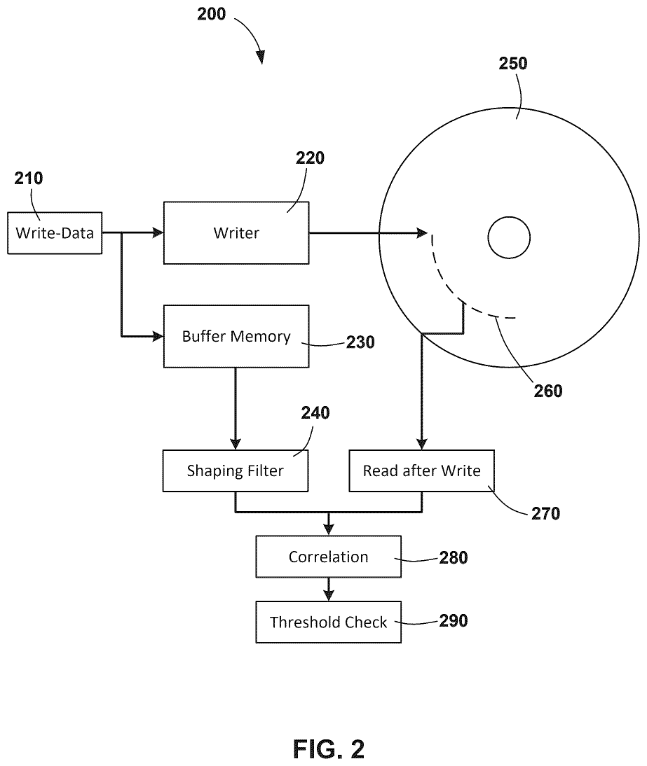

FIG. 2 schematically depicts a RAW method performed in the context of a multi-rev HDD 200 in accordance with aspects of the present disclosure. Upon receiving write-data 210 to be written onto magnetic disk 250, the write-data 210 may be conditioned (for example, using preamp circuitry) and provided to the writer 220 of a recording head that is suspended over spinning magnetic disk 250. The writer 220 writes a data track 260 on the disk 250 to thereby record the write-data 210. Concurrently with or prior to writing onto the disk, the write-data may be saved in buffer memory 230 such as DRAM or other volatile or non-volatile memory. To test, or verify, that the write-data was accurately recorded and retrievable, a read after write 270 can be performed whereby the data track 260 is read back by a reader on the recording head while the write-data 210 still resides in the buffer memory 230.

In accordance with the present disclosure, an emulated read-back signal may be produced by conditioning the write-data with a signal shaping filter 240. Shaping filter 240 conditions the write-data signal so that it can be directly compared to the read-back signal produced by the RAW 270. The shaping filter 240 may employ various filtering techniques as described previously such as a moving Gaussian filter, information retrieved from neighboring tracks, non-linearities or noise, head media spacing information, skew information, timing irregularities, and so forth. The emulated read-back signal produced by filter 240 is then correlated 280 with the RAW read-back signal 270. Correlation 280 may be any suitable comparison of the signals. Other methodologies of verifying the signal quality and signal threshold validation may be used, such as bit-by-bit or point-by-point comparisons. After correlation 280, a threshold check 290 may be performed to determine where errors may exist upon read-back of data track 260. Once it is determined whether the data track 260 is good or not and where any errors may reside, the errors can be tracked in a correction code rather than rewriting the track. For example, an outer code or a simple fault table placed at the end of an SMR band or in a given region of the drive can be used to store corrections rather than rewriting the track. Corrections may be stored off the disk as well, for example in flash memory or other non-volatile media.

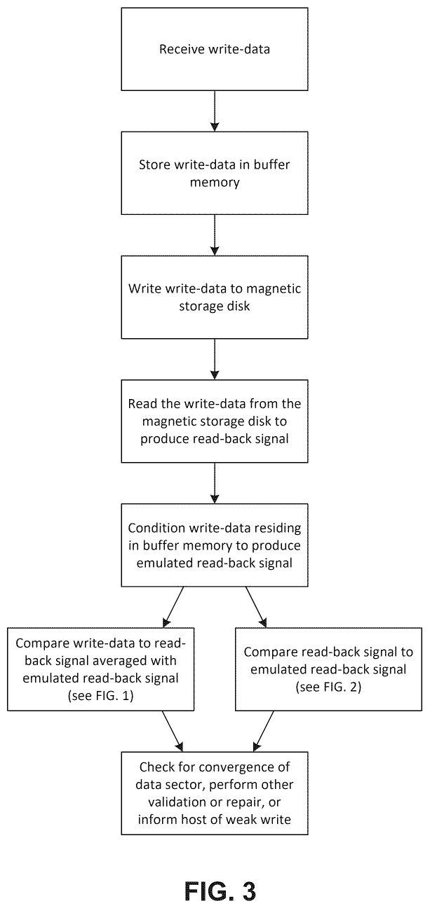

FIG. 3 is a high-level flow chart of steps that may be performed in a multi-rev drive when conducting RAW verification. Write-data is received (for example from a host device) that is to be written onto the magnetic disk. The write-data is stored in the buffer memory and is also written to the magnetic storage disk. When RAW verification is desired, the write-data can be read back from the magnetic disk to produce a read-back signal while the write-data resides in the buffer memory. The write-data residing in the buffer memory is then filtered to produce an emulated read-back signal. For data verification purposes, the read-back signal can be averaged with the emulated read-back signal, and the results can be compared to the write-data, for example as illustrated in FIG. 1. Alternatively, the read-back signal may be directly compared to or correlated with the emulated read-back signal, for example as illustrated in FIG. 2. In certain embodiments, the known write-data residing in the buffer memory may be used as an a priori input into a SOVA in the read channel circuitry along with confidence scaling. This may be done in addition to or alternatively to the comparison steps denoted in FIG. 3. After comparison using the read-back signal and the emulated read-back signal, standard read-back processes may be used to check for convergence of the data sector. Other validation or repair tasks may be performed, or the host may be informed of a weak write as necessary.

In certain aspects, when comparing the read-back signal to the emulated read-back signal, it may be desirable to determine the confidence level in bit value estimates of the emulated read-back signal. This may be accomplished by determining whether or to what degree the written data sector would be reliably recoverable, for example using error correction techniques such as low-density parity check (LDPC). Such an estimate may be generated using heuristics to “guess” at the recoverability of the data without actually performing LDPC iterations. These estimates may be used in filtering and conditioning the emulated read-back signal and/or in performing validation and repair decisions. The level of “conservativeness” in the recoverability estimation heuristics may be adjusted to reflect a desired amount of over-estimation or under-estimation of recoverability.

It should be understood that the various aspects of the present disclosure do not preclude the averaging of multiple read-back signals together in the performance of RAW verification of a written track in multi-rev drives. Averaging of multiple read signals may effectively improve the transmission signal-to-noise ratio when performing read after write verification and developing of error correction values. In certain embodiments, it may be useful to average two or more read-back signals, and then compare the averaged read-back signals using an emulated read-back signal as set forth herein in accordance with various aspects of the present disclosure.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (for example, all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

All scientific and technical terms used herein have meanings commonly used in the art unless otherwise specified. The definitions provided herein are to facilitate understanding of certain terms used frequently herein and are not meant to limit the scope of the present disclosure.

As used herein, the term “configured to” may be used interchangeably with the terms “adapted to” or “structured to” unless the content of this disclosure clearly dictates otherwise.

As used herein, the term “or” refers to an inclusive definition, for example, to mean “and/or” unless its context of usage clearly dictates otherwise. The term “and/or” refers to one or all of the listed elements or a combination of at least two of the listed elements.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” and so forth, means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

What is claimed is:

1. A method for use with a hard disk drive that includes a buffer memory and a magnetic storage disk, the method comprising, while write-data resides in the buffer memory:
writing the write-data to the magnetic storage disk;
after writing, reading the write-data from the magnetic storage disk to thereby produce a read-back signal;
conditioning the write-data residing in the buffer memory to thereby produce an emulated read-back signal;
performing qualitative data verification by comparing the read-back signal to the emulated read-back signal or by comparing a combination of the read-back signal and the emulated read-back signal to the write-data.

2. The method of claim 1, wherein conditioning the write-data comprises emulating signals produced by a reader of the hard disk drive.

3. The method of claim 1, wherein conditioning the write-data comprises using neighboring track information.

4. The method of claim 1, wherein conditioning the write-data comprises adding noise.

5. The method of claim 1, wherein conditioning the write-data comprises shaping the write-data to include features that match signals or noise produced during reading by a recording head of the hard disk drive and/or by the magnetic storage disk.

6. The method of claim 1, wherein conditioning the write-data comprising using finite impulse response filtering, using a Gaussian filter, using a moving average filter, applying adaptive filtering, or using a combination thereof.

7. The method of claim 1, wherein performing qualitative data verification is done in a bit-by-bit or point-by-point manner.

8. The method of claim 1, wherein performing qualitative data verification comprises using signal correlation based on thresholds.

9. The method of claim 1, further comprising storing results of the qualitative data verification as error correction codes.

10. The method of claim 9, wherein the error correction codes are stored in an SMR band, on a dedicated region of the magnetic storage disk, or in a non-volatile memory separate from the magnetic storage disk.

11. The method of claim 1, wherein the read-back signal is produced by averaging results of reading the write-data from the magnetic storage disk two or more times.

12. A method for use with a hard disk drive that includes a magnetic media disk, the method comprising:
operating the hard disk drive in a high-density multi-rev mode; and
performing read after write operations to verify write-data written to the magnetic media disk while operating in the high-density multi-rev mode, the read after write operations using a read-back signal and a conditioned version of the write-data, the read-back signal produced by reading the write-data from the magnetic media disk.

13. The method of claim 12, wherein the read-back signal is produced by averaging results of reading the write-data from the magnetic media disk multiple times.

14. The method of claim 12, wherein the read-back signal is combined with the conditioned version of the write-data to produce an emulated read-back signal that is compared with the write-data in the performing of read after write operations.

15. The method of claim 12, wherein the read-back signal is directly compared to the conditioned version of the write-data in the performing of read after write operations.

16. The method of claim 12, wherein performing read after write operations produces qualitative data verification information stored as error correction codes.

17. The method of claim 12, further comprising generating an estimation of recoverability of the write-data.
